(19) United States
(12) Patent Application Publication
(10) Pub. No.: US 2018/0056529 A1
(43) Pub. Date: Mar. 1, 2018

(54) Knife

(71) Applicant: Chia-Ming Liu, Douliou (TW)

(72) Inventor: Chia-Ming Liu, Douliou (TW)

(21) Appl. No.: 15/352,880

(22) Filed: Nov. 16, 2016

(30) Foreign Application Priority Data
Aug. 29, 2016 (CN) 201620963276.4

(51) Int. Cl. B26B 3/00; B25G 1/00

(52) U.S. Cl. CPC B26B 3/00; B25G 1/00

(57) ABSTRACT

A knife includes a hollow handle, a blade, a connecting component and a plurality of counterweights. The handle extends along an axis and has opposite front and rear ends along the axis. The blade is connected to the front end of the handle. The connecting component is removably connected to the rear end of the handle. The counterweights are removably disposed in the handle and are arranged in series along the axis from an end of the connecting component. Two adjacent ones of the counterweights are separably connected to each other.

### CROSS-REFERENCE TO RELATED APPLICATION

This application claims priority of Chinese Patent Application No. 201620963276.4, filed on Aug. 29, 2016.

### FIELD

The disclosure relates to a knife, and more particularly to a knife with a variable number of counterweights.

### BACKGROUND

A conventional knife is usually manufactured with a fixed weight distribution. However, after long-term use, and after being repeatedly sharpened, the center of gravity of the conventional knife will move rearwardly, thereby affecting comfort of use and manipulation of the conventional knife.

### SUMMARY

Therefore, an object of the disclosure is to provide a knife that can alleviate at least one of the drawbacks of the prior art.

The knife includes a hollow handle, a blade, a connecting component and a plurality of counterweights. The handle extends along an axis and has opposite front and rear ends along the axis. The blade is connected to the front end of the handle. The connecting component is removably connected to the rear end of the handle. The counterweights are removably disposed in the handle and are arranged in series along the axis from an end of the connecting component. Two adjacent ones of the counterweights are separably connected to each other.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating a first embodiment of a knife according to the disclosure;

FIG. 2 is an assembled perspective view of the first embodiment;

FIG. 3 is a sectional view of the first embodiment, illustrating multiple counterweights that are disposed in a handle;

FIG. 4 is another sectional view of the first embodiment, illustrating some of the counterweights being removed;

FIG. 5 is an exploded perspective view illustrating a second embodiment of the knife according to the disclosure;

FIG. 6 is a sectional view of the second embodiment; and

FIG. 7 is another sectional view of the second embodiment, illustrating some of the counterweights being removed.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

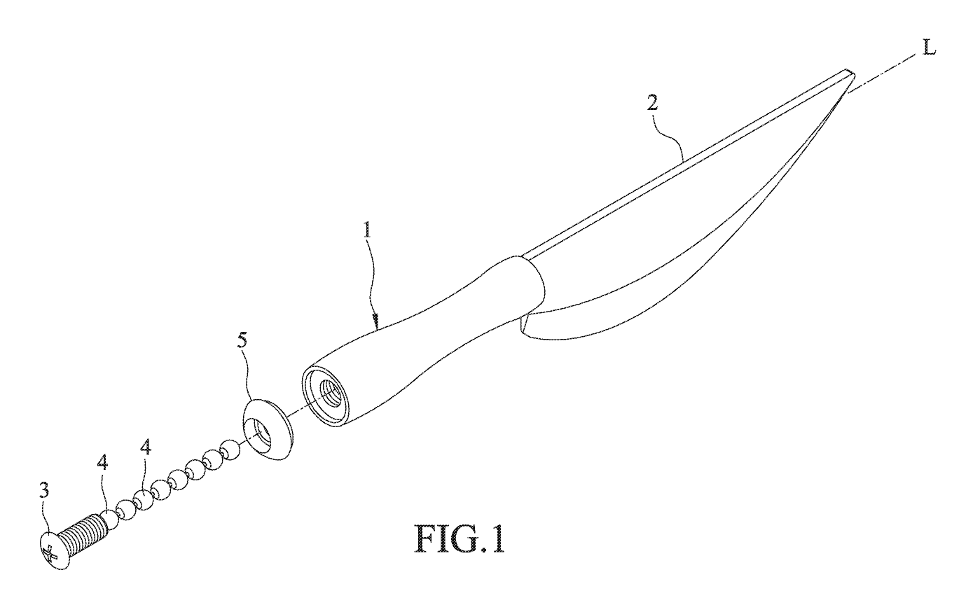

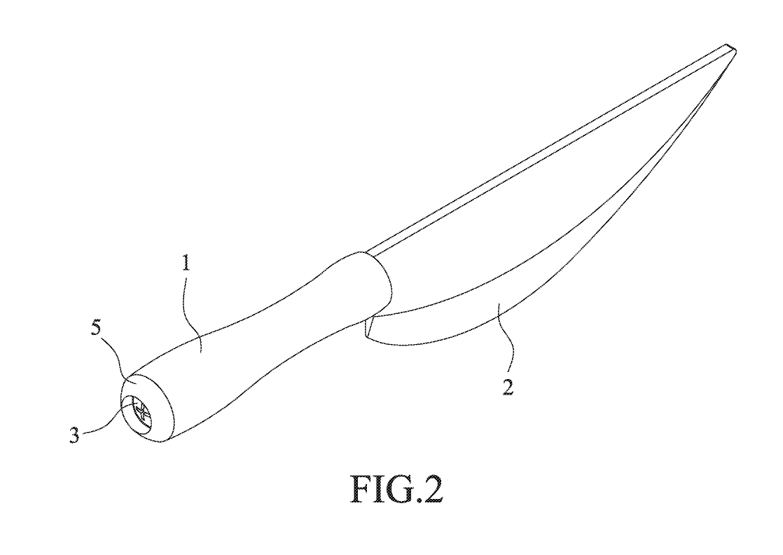

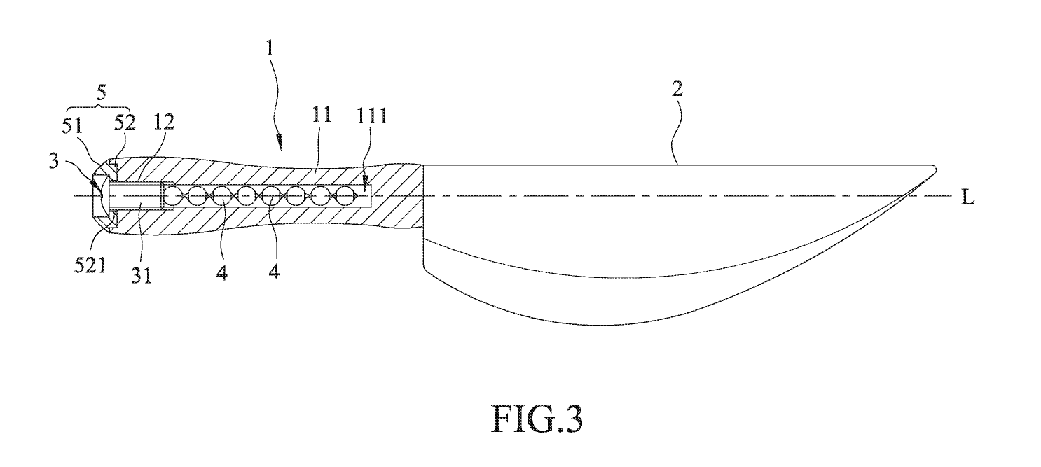

Referring to FIGS. 1 to 3, a first embodiment of a knife is illustrated. The knife includes a hollow handle 1, a blade 2, a connecting component 3, a plurality of counterweights 4, and a rear cover 5.

The hollow handle 1 extends along an axis (L) and has opposite front and rear ends along the axis (L). The blade 2 is connected to the front end of the handle 1. The connecting component 3 is removably connected to the rear end of the handle 1. The counterweights 4 are removably disposed in the handle 1 and are arranged in series along the axis (L) from an end of the connecting component 3, and two adjacent ones of the counterweights 4 are separably connected to each other.

The handle 1 has a handle body 11 that has an inner surrounding surface defining a receiving channel 111 that extends along the axis (L) and that receives the counterweights 4, and an internal thread 12 that is formed on the inner surrounding surface.

The connecting component 3 has a threaded portion 31 that is engaged with the internal thread 12 of the handle 1.

The rear cover 5 is connected removably to the rear end of the handle 1. Specifically, the rear cover 5 has a hollow body portion 52 formed with an internal thread 521, and a head portion 51 connected to an end of the body portion 52 that is opposite to the handle body 11. In this embodiment, the connecting component 3 is configured as a bolt with a bolt head abutting against the body portion 52 of the rear cover 5 (i.e., the body portion 52 is clamped between the handle body 11 and the bolt head of the connecting component 3) and with the threaded portion 31 being engaged removably with the internal thread 521 of the body portion 52 of the rear cover 5 and the internal thread 12 of the handle 1.

In this embodiment, each of the counterweights 4 is magnetic and substantially ball-shaped, so that two adjacent ones of the counterweights 4 are separably connected to each other by virtue of magnetic attraction. The connecting component 3 is a magnetic bolt that can be separably connected with the counterweights 4 by virtue of magnetic attraction. However, the configurations of the counterweights 4 may vary in other embodiments. For example, two adjacent ones of the counterweights 4 may be separably connected to each other by virtue of threaded connection or by virtue of fitted engagement.

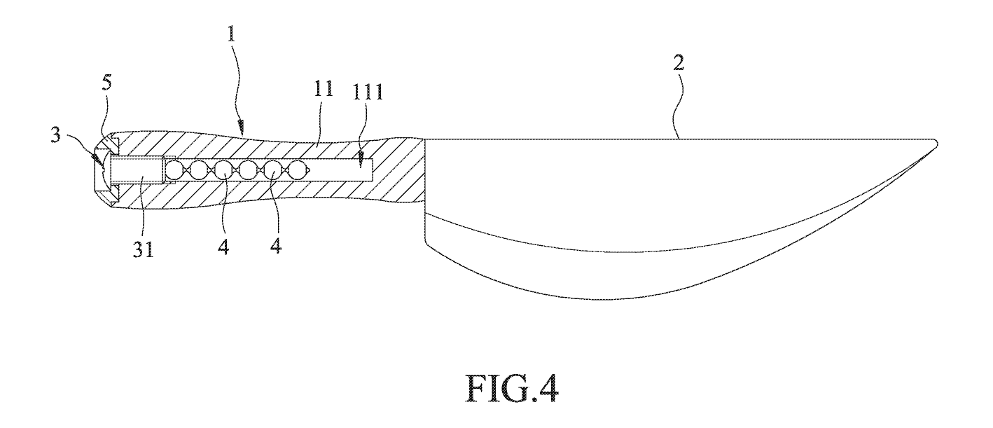

After being used for a long period of time, the center of gravity of the knife will move rearwardly due to abrasion. To solve this problem, a user of the knife can separate the connecting component 3 accompanied by the counterweights 4 from the handle body 11, remove some of the counterweights 4, and reassemble the connecting component 3 and the remaining counterweights 4 back to the handle body 11 as shown in FIG. 4. Therefore, weight distribution of the knife is properly adjusted.

The first embodiment has the following advantages. First, by varying the number of the counterweights 4 disposed in the handle 1, the weight distribution of the knife can be effectively adjusted so as to improve comfort of use and manipulation of the knife. Second, the structure of the knife of this disclosure is simple and assembly of the knife is convenient.

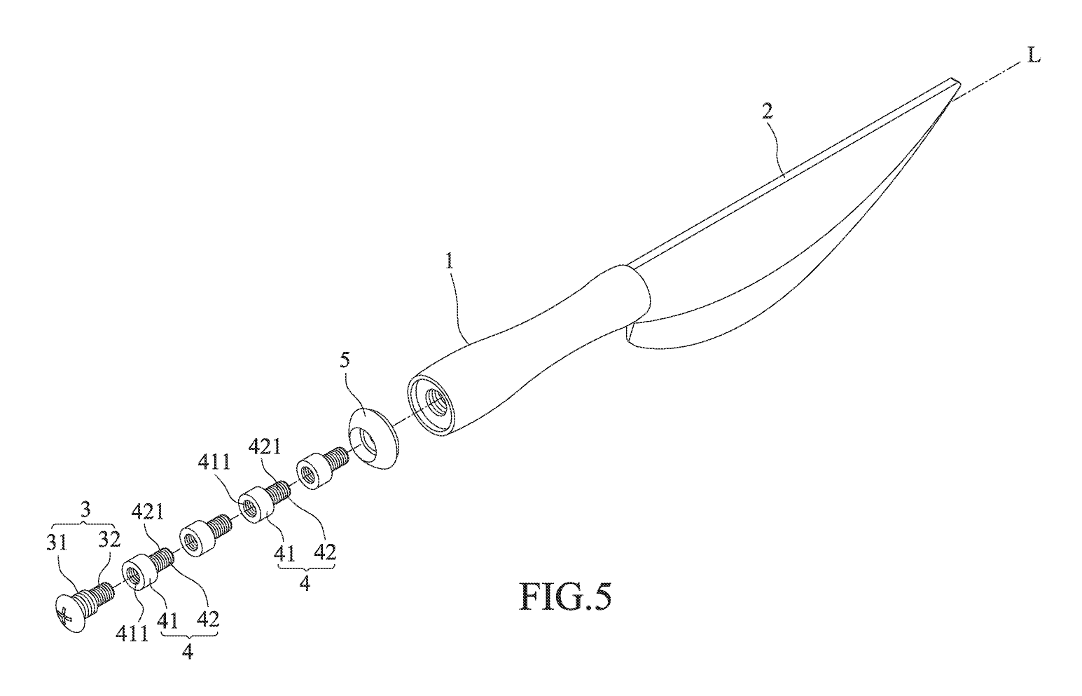

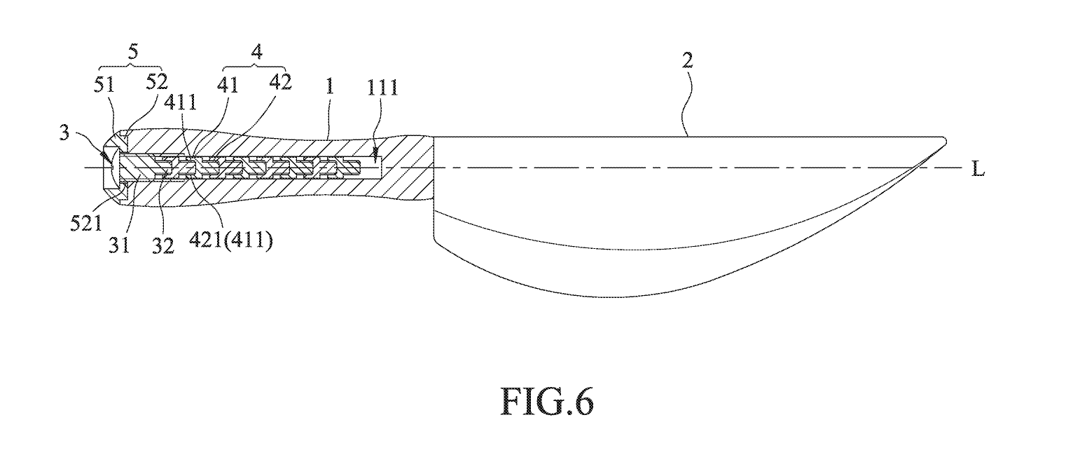

Referring to FIGS. 5 to 7, a second embodiment of the knife according to the disclosure is illustrated. The second embodiment is similar to the first embodiment, but is different in what is addressed in the following sections.

In this embodiment, each of the counterweights 4 has a head part 41 and a body part 42. The head part 41 is hollow and is formed with an inner thread 411. The body part 42 is formed with an outer thread 421. Two adjacent ones of the counterweights 4 are connected to each other with the inner thread 411 of the head part 41 of one of the two adjacent ones of the counterweights 4 being separably and threadedly engaged with the outer thread 421 of the body part 42 of the other one of the two adjacent ones of the counterweights 4.

The connecting component 3 further has a protruding portion 32 protruding from the threaded portion 31 along the axis (L), formed with an external thread, and separably and threadedly engaged with the inner thread 411 of the head part 41 of a farthest one of the counterweights 4 from the blade 2.

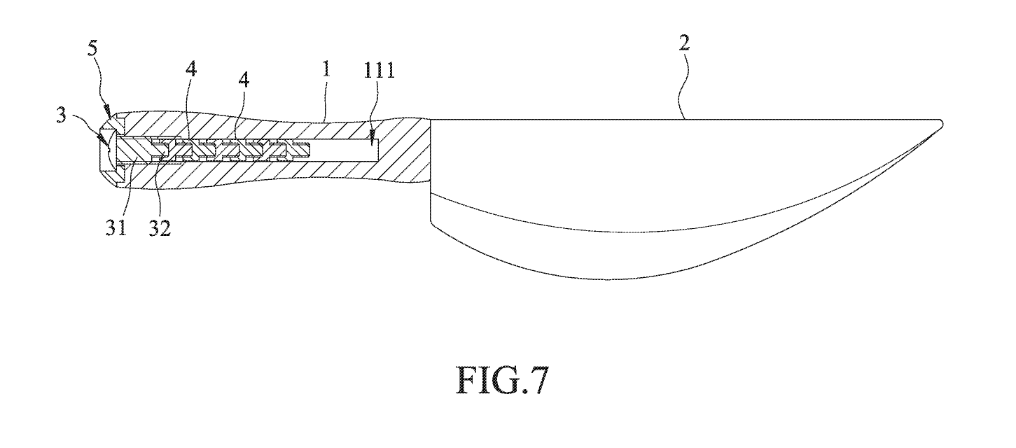

By varying the number of the counterweights 4 disposed in the handle 1 as shown in FIG. 7, the weight distribution of the knife can be effectively adjusted. In consequence, the second embodiment could achieve the same goal and effect as the first embodiment.

In summary, the knife of this disclosure enables the user to adjust the weight distribution of the knife by varying the number of the counterweights disposed in the handle, so that the comfort of use and the manipulation of the knife are improved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A knife comprising:
a hollow handle extending along an axis and having opposite front and rear ends along the axis;
a blade connected to said front end of said handle;
a connecting component removably connected to said rear end of said handle; and
a plurality of counterweights removably disposed in said handle and arranged in series along the axis from an end of said connecting component, two adjacent ones of said counterweights being separably connected to each other.

2. The knife as claimed in claim 1, wherein two adjacent ones of said counterweights are separably connected to each other by virtue of magnetic attraction.

3. The knife as claimed in claim 1, wherein two adjacent ones of said counterweights are separably connected to each other by virtue of threaded connection.

4. The knife as claimed in claim 1, wherein two adjacent ones of said counterweights are separably connected to each other by virtue of fitted engagement.

5. The knife as claimed in claim 1, wherein:
said handle has a handle body that has an inner surrounding surface defining a receiving channel that extends along the axis and that receives said counterweights, and an internal thread that is formed on said inner surrounding surface; and
said connecting component has a threaded portion that is engaged removably with said internal thread of said handle.

6. The knife as claimed in claim 5, further comprising a rear cover that is connected removably to said rear end of said handle, and that has a hollow body portion formed with an internal thread, and a head portion connected to an end of said body portion that is opposite to said handle body, said threaded portion of said connecting component being engaged removably with said internal thread of said body portion of said rear cover and said internal thread of said handle.

7. The knife as claimed in claim 6, wherein each of said counterweights is magnetic and substantially ball-shaped.

8. The knife as claimed in claim 6, wherein:
each of said counterweights has
a head part that is formed with an inner thread, and
a body part that is formed with an outer thread, two adjacent ones of said counterweights being connected to each other with said head part of one of said two adjacent ones of said counterweights being separably and threadedly engaged with said body part of the other one of said two adjacent ones of said counterweights; and
said connecting component further has a protruding portion protruding from said threaded portion along the axis, formed with an external thread, and separably engaged with said head part of a farthest one of said counterweights from said blade.
